(19) United States
(12) Patent Application Publication
(10) Pub. No.: US 2013/0003757 A1
(43) Pub. Date: Jan. 3, 2013

(54) SYNTONIZED COMMUNICATION SYSTEM

(75) Inventors: Robert Boatright, Sandy, UT (US); Richard Allen Kreifeldt, South Jordan, UT (US); David Olsen, Kaysville, UT (US)

(73) Assignee: Harman International Industries, Incorporated, Northridge, CA (US)

(21) Appl. No.: 13/173,661

(22) Filed: Jun. 30, 2011

(51) Int. Cl. H04L 7/00; H04J 99/00

(52) U.S. Cl. 370/474

(57) ABSTRACT

A computing device may include a processor, an internal bus, and a network interface controller configured to communicate over a network. The processor and the network interface controller may communicate over the internal bus. The computing device may operate in a system that generates one or more media streams from time-stamped packets received over a network. The packets may include audio, video, or a combination of both, sampled at a rate determined by a master media clock. Timestamps in the packets may be presentation times based on values of a remote real-time clock at the transmitter that is synchronized with a local real-time clock at a receiver. The system may generate the media streams from the media stream samples and present the sampled data according to the presentation times.

### BACKGROUND OF THE INVENTION

1. Technical Field

This application relates to data communication and, in particular, to audio and/or video data communication in a syntonized communication system.

2. Related Art

Audio/video media streams may be transmitted from a transmitter to a receiver. The transmitter may encapsulate samples of a media stream in packets, and transmit the packets to the receiver. The packets may be isochronous packets transmitted over a network.

### SUMMARY

A computing device, such as a personal computer may operate as a transceiver in an Audio/Video Packet Management (AVPM) System. The computing device may include a network interface controller, or network interface module, an internal bus, or internal bus module, and a processor. The processor may communicate with the network interface controller over the internal bus. Each of the processor and the network interface controller may include a real-time clock (RTC). Communication of timing information over the internal bus between the processor and the network interface controller may allow the respective RTCs in the processor and the network interface controller to be synchronized to a common system time.

The AVPM system may operate transmitters and/or receivers and one or more grandmaster nodes providing a corresponding grandmaster clock, network time, or system time. Devices in the AVPM system that are not grandmaster nodes are slave nodes that are synchronized to the grandmaster network clock, by synchronization of a respective RTC in a respective device to the grandmaster clock. When the processor is the grandmaster node, a processor network clock associated with the processor may operate as the RTC and be the grandmaster network clock.

Synchronization of slave nodes, such as a network interface clock of the network interface controller to the grandmaster clock may be performed based on synchronization (synch) information provided by the processor network clock provided to the network interface controller via the internal bus. For example, synch packets may be provided by the processor over the internal bus to the network interface controller and other devices included in the AVPM system to facilitate synchronization of the devices to the grandmaster clock.

When the processor is not the grandmaster node, and is therefore a slave node in the AVPM system, synchronization of the processor network clock may be based on synch packets received by the network interface controller from over the network that are passed to the processor over the internal bus.

The AVPM system may also include master media clocks operated by corresponding media clock master nodes. The media clock master nodes may be devices in the AVPM system operating as transmitters. Alternatively, or in addition, any devices in the AVPM system may operate as media clock master nodes for one or more other devices operating in the AVPM system. Devices in the AVPM system that are not media clock master nodes, such as receivers, are slave nodes that may be synchronized to the media clock master node of a particular clock domain. There may be multiple clock domains within a given AVPM system. When the processor is the media clock master node, a processor media clock associated with the processor may be the media clock master. The media clock master node does not necessarily have to be co-located in the same node as the grandmaster node.

Synchronization of other media clocks, such as a network interface clock of the network interface controller may be performed based on recovery of timing information of the processor media clock provided to the network interface controller via the internal bus. For example, time stamped packets may be provided by the processor over the internal bus to the network interface controller and other devices included in the AVPM system to facilitate synchronization of the devices to the master media clock.

When the processor is not a media clock master node, and is therefore a slave node in the AVPM system, synchronization of the processor media clock may be based on time stamped packets received by the network interface controller from over the network that are passed to the processor over the internal bus.

Synchronization of the different media clocks of the devices in the AVPM system and synchronization of different RTCs in respective devices allows the devices to be network time aware and presentation time aware. Thus, latency in the network, and also in the network interface controller and the internal bus may be compensated to achieve streaming media presentations. In the case of the computing device, both the network interface controller and the processor are individually network time aware and presentation time aware. Accordingly, since the processor is network time aware, and the latency of the internal bus is accounted for, the processor may also provide timely presentation of media streams similar to other devices on the network. The difference between the processor and other devices in the AVPM system being that the processor is not on the network, but rather communicates over a dedicated bus internal to the computing device with the network interface controller, which is in communication over the network.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is an example of a computing device operating as a receiver in an Audio/Video Packet Management System (AVPM System).

FIG. 2 is an example of a time-stamped packet that includes an IEEE P1722 data packet.

FIG. 3 is an example of a synch packet encapsulated in an internal bus protocol packet.

FIG. 4 is a block diagram of the receiver of FIG. 1.

FIG. 5 is an example operational block diagram of the computing device related to network time within the AVPM system.

FIG. 6 is a second part of the operational block diagram of FIG. 5.

FIG. 7 is a third part of the operational block diagram of FIG. 5.

FIG. 8 is another example operational block diagram of the computing device related to time stamps within the AVPM system.

FIG. 9 is a second part of the operational block diagram of FIG. 8.

### DETAILED DESCRIPTION

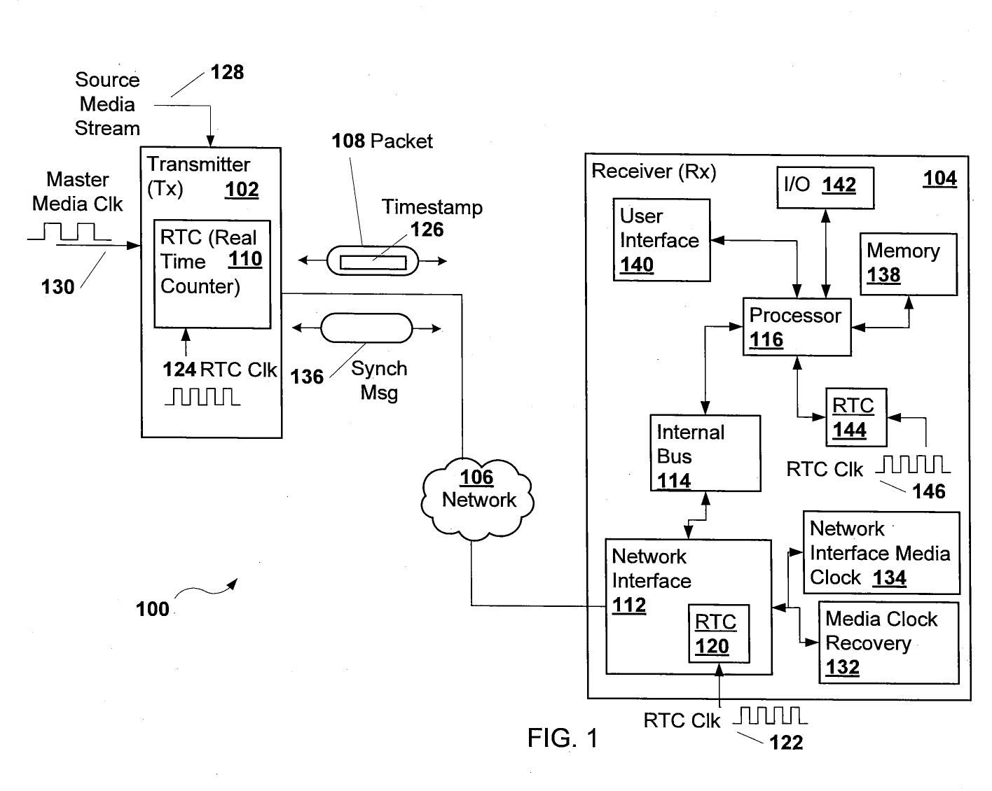

FIG. 1 illustrates an example of an Audio/Video Packet Management System (AVPM System) 100. The AVPM system 100 may include a transmitter 102 and a receiver 104. Alternatively, the AVPM system 100 may include any number of transmitters and receivers. In addition, transmitters in one data exchange may be receivers in another data exchange. Further, transmitters may be only transmitters, and receivers may be only receivers. Thus, although illustrated in FIG. 1 as a transmitter 102 and a receiver 104, these devices may be transceivers in other examples.

The transmitter 102 may communicate with the receiver 104 over a network 106. The network 106 may be a local area network (LAN), a wireless local area network (WLAN), a personal area network (PAN), a wide area network (WAN), the Internet, any other now known or later developed communications network, or any combination thereof. For example, the network 106 may include a packet-switched network. The network 106 may include an asynchronous network. The network 106 may transport any form of packets containing data. The network 106 may also transport packets between devices other than the transmitter 102 and the receiver 104.

The transmitter 102 may be a device that transmits time-stamped packets 108 to the receiver 104 over the network 106. The receiver 104 may be a device referred to as a listener and/or a media extractor. Examples of the transmitter 102 and receiver 104 include a circuit, an application specific integrated circuit (ASIC), a field programmable gate array (FPGA), a computer, a networking card, an audio digital signal processor, a video signal processor, a multimedia device, such as a networked video receiver configured to receive a video stream with multi-channel audio, or any other device capable of communication of audio and/or video data over the network 106.

During operation of the AVPM system 100, the transmitter 102 may encapsulate a media stream into time-stamped packets 108 that the transmitter 102 transmits to the receiver 104 over the network 106. The media stream may be transmitted in association with a unique stream identifier.

The receiver 104 may receive packets, including the time-stamped packets 108 transmitted by the transmitter 102, from the network 106. The receiver 104 may be programmed to receive one or more media streams. For example, the receiver 104 may include one or more subscribed media stream identifiers stored in memory that identify the media streams that the receiver 104 is to receive and process. Subscribed media streams include media streams that the receiver 104 generates, which may be a subset of the complete set of media streams whose media streams samples are received by the receiver 104. If the receiver 104 includes a subscribed media stream identifier that matches the unique stream identifier associated with the time-stamped packets 108, then the receiver 104 may generate a local media stream from the time-stamped packets 108.

In FIG. 1, the transmitter 102 may include a remote real-time clock or counter (RTC) 110. In addition, the receiver 104, which is depicted as a computing device, may include a network interface module 112, an internal bus module 114, and a processor 116. In other examples, the transmitter 102 may also, or may alternatively, be depicted as a computing device. In the receiver 104, the network interface module 112 may include a local real-time clock or counter (RTC) 120. In other examples, the local RTC 120, or network interface RTC, may be included as a separate device, or as part of another module included in the receiver 104. The term “local” means at, or included in, the receiver 104, and the term “remote” means at, or included in, a node on the network 106 other than the receiver 104, such as the transmitter 102.

The network interface module 112, or network interface controller, may be any form of network communication device or system capable of processing time-stamped packets 108 as described later. In one example, the network interface module 112 includes a networking interface card having a processor. The term “module” may be defined to include one or more executable modules. As described herein, modules are defined to include software, hardware or some combination thereof executable by a processor. Software may include instructions stored in memory, or a memory device that are executable by a processor. Hardware may include various devices, components, circuits, gates, circuit boards, and the like that are executable, directed, and/or controlled for performance by a processor.

The local RTC 120 and the remote RTC 110 may include a counter that increases or decreases at a rate determined by a clock, such as a local RTC clock 122 at the receiver 104 and a remote RTC clock 124 at the transmitter 102. For example, the local RTC 120 and the remote RTC 110 may be implemented as accumulation registers, digital counters, real-time clock ICs (integrated circuits) or any other suitable devices. A digital counter may be any semiconductor device that counts the number of times a digital event has occurred. The digital event may be a rising or falling edge of the respective RTC clocks, 122 or 124, for example. The local RTC 120 and the remote RTC 110 may be synchronized using any clock synchronization protocol.

The time-stamped packet 108 may be a data packet that includes a timestamp 126. In addition, the time-stamped packet 108 may include a payload. The payload may include samples of a source media stream 128. Alternatively or in addition, the payload may not include samples of the source media stream 128. Examples of the time-stamped packet 108 include an IEEE P1722 packet or any other isochronous packet. A media stream may include a substantially continuous flow of multimedia, such as audio, video, or a combination thereof. The media stream may be a digital stream or an analog stream. The source media stream 128 may be the media steam that the transmitter 102 packetizes and transmits to the receiver 104.

The timestamp 126 may include a value read from the remote RTC 110 or a value derived from a value read from the remote RTC 110. The timestamp 126 may be dimensionless. For example, the timestamp 126 may be a value of an accumulator register included in the remote RTC 110. Alternatively, the timestamp 126 may include a unit of time. In one example, the timestamp 126 may be a sum of a value read from the remote RTC 110 and a delay value, such as a maximum transmission delay between the transmitter 102 and any receiver, such as the receiver 104.

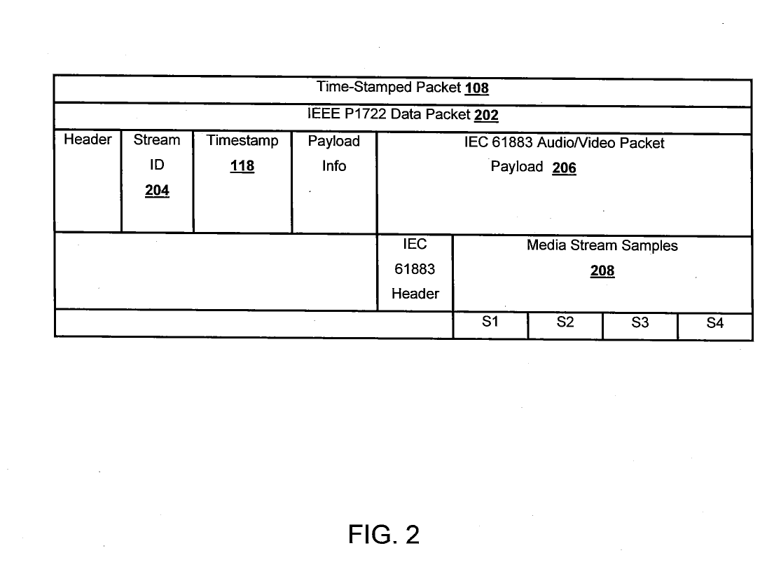

FIG. 2 illustrates an example of the time-stamped packet 108 that includes an IEEE P1722 data packet 202. The P1722 data packet 202 may include a stream ID (identifier) 204, the timestamp 126, and a payload 206. The payload 206 of the P1722 data packet 202 may include formatted data, such as an IEC 61883 audio/video packet or data in any other suitable format. The payload 206 may include media stream samples 208, such as media stream samples included in an IEC 61883 audio/video packet. In FIG. 2, the payload 206 includes four of the media stream samples 208 from one source media stream or channel. Alternatively or in addition, a single one of the time-stamped packets 108 may include media stream samples 208 from two or more source media streams or channels. For example, the payload 206 may include one or more data blocks, where each data block includes the media stream samples 208 for a number of media channels. Alternatively or in addition, the transmitter 102 may include the media stream samples 208 from a first source media stream in a first P1722 data packet 202 and the media stream samples 208 from a second source media stream in a second P1722 data packet 202. The stream ID 204 in the first P1722 data packet 202 may identify the first media stream, and the stream ID 204 in the second P1722 data packet 202 may identify the second media stream.

In FIG. 1, in addition to transmission and receipt of packets 108, the transmitter 102 and receiver 104 may also recover or provide a master media clock. The master media clock may be recovered and used to synchronize a sample rate at which data is sampled, or clocked into and out of the packets 108, at respective transmitters 102 and receivers 104. The master media clock may be provided by any one or more clocks in the AVPM system 100. Determination of which devices are to be media clock master nodes, and more specifically which clocks in which devices are to be designated, may be based on devices operating as the transmitter 102, user settings, or any other criteria. For example, anytime a device operates as a transmitter 102, the device may be designated as a media clock master node and transmit timestamps used by a receiver 104 to recover the master media clock.

Alternatively or in addition, the master media clock may be designated depending on the robustness and availability of a device. Robustness may refer to, for example, the accuracy of the clock present in a device, the reliability of the device, or any other criteria, and/or may be a user settable parameter in the AVPM system. In this example configuration, subscriptions may be used to synchronize any number of devices to the media clock master node. In other examples, other criteria may be used to designate the media clock master nodes. In addition, in some examples, the grandmaster clock and the master media clock may be the same, however, in this configuration, the AVPM system may be limited to a single clock domain.

In FIG. 1, a master media clock 130 may be included in the transmitter 102 when the transmitter 102 is operating as a media clock master node. The master media clock 130 is a different clock than the RTC clock 124 included as part of the RTC 110. Recovery of the master media clock 130 by slave devices in the AVPM system 100 may be by generation of a media clock. In FIG. 1, the network interface module 112 may generate a network interface media clock 134 based on the time-stamped packets 108 and the local RTC 120 in the receiver 104. Recovery of the media clock at the receiver 104, and syntonization and synchronization with the master media clock 130 at the receiver 104 may rely on the remote RTC 110 in the transmitter 102 and the local RTC 120 in the receiver 104 being synchronized.

The receiver 104 may also include a media clock recovery module 132 that generates the network interface media clock 134 from the timestamps in the time-stamped packets 108 and the RTC 116 of the network interface module 112. For example, the media clock recovery module 132 may include a frequency synthesizer and logic for recovering the network interface media clock 134. In one example, the media clock recovery module 132 may include a media clock recovery device. Examples of the media clock recovery device include a digital circuit, a field programmable gate array (FPGA), a frequency synthesizer, a microcontroller, or any other hardware or combination of hardware and software that generates the network interface media clock 134 from the timestamps in the time-stamped packets 108 and the RTC 120 in the network interface module 112. Media clock recovery, syntonization and synchronization are further described later.

In FIG. 1, in addition to transmission and receipt of packets 108, the transmitter 102 and receiver 104 may also be synchronized to network time using a grandmaster clock. The grandmaster clock is one or more clocks within the system to which the receiver 104 and the transmitter 102 are synchronized. The grandmaster clock may be provided by any clock in the AVPM system 100. Determination of which devices are to be a grandmaster node, and more specifically which clock in which devices, are to be designated as providing the grandmaster clocks may be determined by any of a number of methods. The AVPM system may include multiple grandmaster clocks. As a non-limiting example, the following discussion will discuss a grandmaster clock, but should be construed as describing one or more grandmaster clocks.

In a first operational mode of the AVPM system 100, the grandmaster clock may be fixed. Thus, all the devices in the AVPM system 100 may be provided an indication of which device (clock) is the grandmaster clock when operating in the first operational mode. For example, a clock associated with the transmitter 102 or the receiver 104 may be designated as the grandmaster clock, or master, to which the remaining transmitters and receivers are slaves. In a second operational mode of the AVPM system 100, any device may be the grandmaster node operating the grandmaster clock depending on the robustness and availability of the device. Robustness may refer to, for example, the accuracy of the clock present in a device, the reliability of the device, or any other criteria, and may be a user settable priority indication, or any other criterion. As described later, during operation in the second operational mode, the devices may communicate with each other over the network 106 to advertise their availability to operate as the grandmaster clock, and negotiate to be designated the grandmaster clock. Negotiation and designation may be based on availability of the device on the network, processing capability of the device, accuracy of the clock in the device, designated priority of the devices, or any other criteria.

In a third operational mode, certain devices may be designated as never being a grandmaster node operating the grandmaster clock. Thus, the receiver 104 may be designated as never being the grandmaster node, and therefore always being a slave to another device. Other devices that are not designated as never being the grandmaster node may communicate and negotiate to be the grandmaster node as in the second operational mode.

In any of the first operational mode, the second operational mode, or the third operational mode, the transmitter 102 may be the media clock master node providing the master media clock. Alternatively, the master media clock may be provided to the transmitter 102 by another device in the network 116 and recovered by the transmitter 102.

The local and remote RTCs 120 and 110 may be synchronized to the grandmaster clock using a clock synchronization protocol. The clock synchronization protocol may include a protocol for exchanging synch messages 136 between nodes to synchronize the clock at a receiving node with the clock at the transmitter or with a clock at some other node. Examples of the clock synchronization protocol that use synch messages 136 include IEEE (Institute of Electrical and Electronics Engineers) 1588:2002 Standard for a Precision Clock Synchronization Protocol for Networked Measurement and Control Systems, and IEEE 802.1AS Precision Time Protocol (PTP) in IEEE 802.1AS Standard for Local and Metropolitan Area Networks—Timing and Synchronization for Time-Sensitive Applications in Bridged Local Area Networks. For example, in the second operational mode of the AVPM system 100, PTP nodes may exchange synch messages 136, such as PTP messages, in the form of Ethernet messages that synchronize the PTP nodes to a common time reference by providing clock master selection and negotiation mechanisms, link delay measurement and compensation, and clock rate matching and adjustment mechanisms. In other examples, other forms of synch messages may be used.

The synch messages 136 may be separate synch packets transmitted between the grandmaster node and the other devices at predetermined intervals, such as eight times per second. Alternatively, or in addition, the synch messages 136 may be included in the packets 108 at predetermined time intervals, such as about eight times per second. PTP provides a Best Master Clock Algorithm (BMCA), which is an algorithm for negotiating which of the clocks in the PTP nodes is to be the grandmaster clock. In particular, BMCA describes a negotiation and a signaling mechanism that identifies a grandmaster node. Once the grandmaster node is selected, synchronization may begin automatically between the grandmaster node and the other PTP nodes known as slave nodes. PTP messages transmitted from the grandmaster node, the slave nodes, or both, may include a timestamp value taken from a real-time clock (RTC), such as the RTC 110 in the transmitter 102. The slave nodes may compare a value of the RTC of the slave nodes, such as the RTC 120 at the receiver 104, with a value of the RTC at the grandmaster node. By using link delay measurement and compensation techniques, the slave nodes may synchronize the RTC in each of the slave nodes with the RTC at the grandmaster node. Once the RTCs are synchronized with each other, periodic messages, such as synch messages 136, may provide information that enables maintaining a substantially synchronized state, such the PTP rate matching adjustment algorithms. As a result, the devices, such as PTP nodes, may remain synchronized to a common system time.

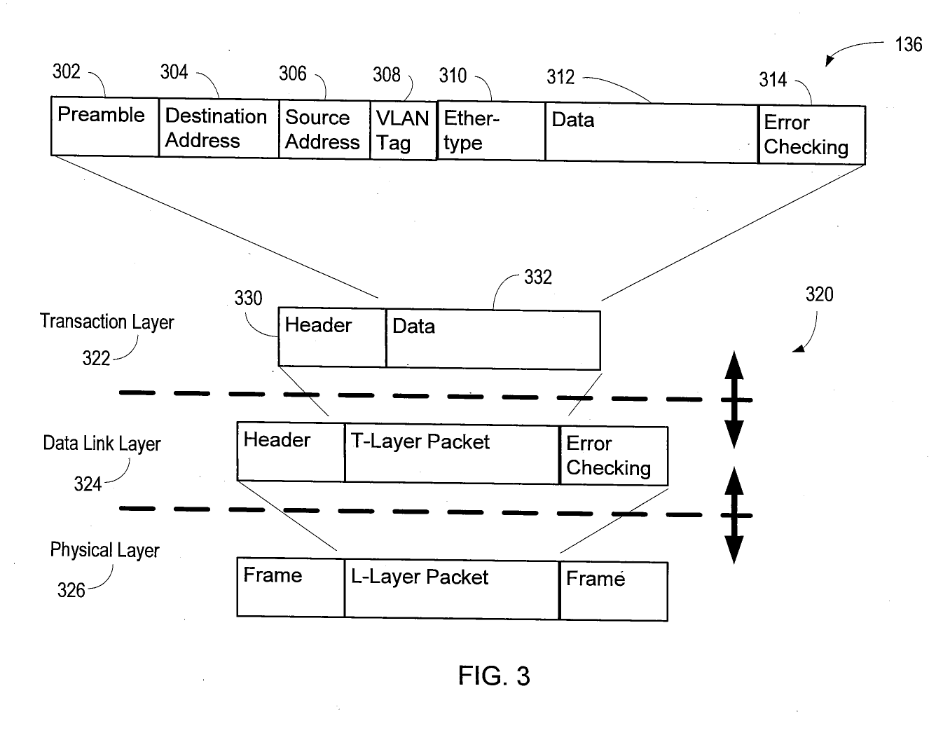

FIG. 3 is an example of a synch packet 136, in the form of an IEEE802.1AS PTP packet. In FIG. 3, the synch packet 136 includes a preamble 302, a destination address 304, a source address 306, a VLAN tag 308, an Ether-type 310, data 312 and an error check 314. The preamble 302 provides notification to the receiving device. In one example, the preamble may be an 8 byte (Manchester encoded) field, which may include bits indicating a start of a frame. For example, the preamble 302 may include 2 bits called SOF (Start of Frame), which notify the receiving station that a frame is arriving. The destination address 304 and the source address 306 are either the grandmaster node or a slave node between which the synch packet 136 is being transmitted. The VLAN tag 308 is a network identifier, such as a virtual LAN identifier that provides the domain. The Ether-type is a protocol identifier of the packet, which may, for example, identify a synch packet as a PTP packet and provide a PTP version and a transport. The data 312 is the payload of the synch packet 136, which may include clock master selection and negotiation mechanisms, link delay measurement and compensation, and clock rate matching and adjustment mechanisms, and any other data related to negotiating the grandmaster node, and synchronizing with the grandmaster clock. The error check 314 may be any form of packet error checking that detects bit errors. In addition, the synch packet 136 may include flags, interval information, and any other protocol based information.

In FIG. 1, while being encapsulated into the time-stamped packets 108 by the transmitter 102, the source media stream 128 may be provided to the transmitter 102 at a rate associated with the master media clock provided by the media clock master node. Thus, where the transmitter 102 is the media clock master node, the master media clock 130 may be included in the transmitter 102 in addition to the RTC 110 and associated RTC clock 124. In the case where transmitter 102 is not the master media clock node, as in FIG. 1, the master media clock 130 may be supplied to the transmitter 102, and the RTC clock 124 may be included in the transmitter 102. Regardless of the location of the master media clock node, characteristics of the master media clock 130, such as frequency, may be different than the frequency of the RTC clock 124 at the transmitter 102.

The timestamp 126 in the time-stamped packets 108 may be values of the RTC 110 at the transmitter 102 sampled at a frequency determined by the master media clock 130. For example, the transmitter 102 may sample the RTC 110 at the transmitter 102 at a frequency equal to the frequency of the master media clock 130. Additionally, the sampled values of the source media stream 128 may have been sampled at a rate determined by the master media clock 130. For example, the sampled values of the source media stream 128 may have been sampled at a frequency equal to the frequency of the master media clock 130. Each timestamp 126 may include a value of the RTC 110 sampled as the transmitter 102 prepared to send the time-stamped packet 108. Each of the time-stamped packets 108 may include the timestamp 126 and one or more sampled values, or portions, of the source media stream 128. For example, the transmitter 102 may generate two packets, where each one of the packets includes a timestamp 126 for the portion of the source media stream 128 included in that packet 108.

In FIG. 1, the time-stamped packets 108 and synch packets 136 may be received and processed with the network interface module 112 and passed to the internal bus module 114 for communication to the processor 116. The internal bus module 114, may be an internal communication bus within the computing device, such as a peripheral component interconnect (PCI) bus, a peripheral component interconnect express (PCI-e), or any other data highway internal to a computing device such as a personal computer having a physical transport layer. Accordingly, the internal bus module 114 may communicate internal bus data packets in parallel communication or serial communication in a protocol specific to the internal bus module 114. The internal bus module 114 may be a dedicated communication bus used only for communication internal to the computing device, such as between the network interface module 112 and the processor 116. Thus, data may be communicated over the internal dedicated communication bus between the network interface module 112 and the process 116 absent address information identifying either the network interface module 112 or the processor 116.

The processor 116 may be a component in any one of a variety of systems. For example, the processor 116 may be part of a personal computer or a workstation. In FIG. 1, the processor 116 is incorporated into a computing device, such as a personal computer. The processor 116 may be one or more general processors, digital signal processors, application specific integrated circuits, field programmable gate arrays (FPGA), digital circuits, analog circuits, combinations thereof, or other now known or later developed devices for analyzing and processing digital and analog data. The processor 116 may operate in conjunction with a software program, such as code generated manually (i.e., programmed). In one example, the processor 116 may execute instructions to operate an operating system such as Microsoft Windows, Linux, Macintosh, or any other operating system. In addition, the processor 116 may execute instructions to control operation of the modules. The functions, acts, tasks, modules, and/or components described herein may be performed, directed, controlled or represented by a programmed processor executing instructions stored in memory 138. The functions, acts or tasks may be independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The processor 116 may be coupled with memory 138. Memory 138 may be a separate component or included in the processor 116. Software in the form of instructions executable by the processor 116 and data accessible to the processor 116 may be stored in memory 138. Memory 138 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 138 may include a random access memory for the processor 116. Alternatively or in addition, the memory 138 may be a cache memory of a processor, the system memory, or other memory. The memory 138 may also include an external storage device or database for storing instructions and recorded data. Examples include a hard drive, compact disc (“CD”), digital video disc (“DVD”), memory card, memory stick, floppy disc, universal serial bus (“USB”) memory device, or any other device operative to store instructions and/or data.

The receiver 104 may also include a user interface 140. The user interface 140 may include a display, such as a touch screen, a pointing device, a keyboard, a microphone, a speaker, indicators, buttons, sliders, or any other components that allow a user to provide commands and receive information from the receiver 104. Commands may be provided by a user via the user interface 140 in the form of physical contact by the user, voice commands, use of the pointing device, or any other mechanism for converting the commands of a user to signals received by the processor 116.

The receiver 104 may also include an input/output (I/O) module 142. The I/O module 142 may receive and provide signals to components, systems or networks internal or external to the receiver 104, such as a digital versatile/video disc (DVD) player, display, a loudspeaker, a memory storage device, an external communication bus, such as a MOST bus, or a CAN bus, or any other component or device. The I/O module 142 may also communicate in various protocols or formats, such as universal serial bus (USB), Firewire, MOST, CAN, or any other protocol or communication language, either proprietary, or non-proprietary.

The processor 116 may also include a local RTC 144, or processor RTC. The local RTC 144 may include a counter that increases or decreases at a rate determined by a clock, such as a local RTC clock 146. The local RTC clock 146 may be dedicated clock, or a shared clock associated with the processor 116. For example, the local RTC 144 may be implemented as accumulation registers, digital counters, real-time clock ICs (integrated circuits) or any other suitable devices. The local RTC 144 may be synchronized using any clock synchronization protocol. For example, the local RTC 144 may be synchronized with the local RTC 120, the remote RTC 110, or any other clock signal.

Audio/video data, or media data, received at the network interface module 112 from the network 106 may be passed to the processor 116 over the internal bus module 114. Similarly, media data may be received by the network interface module 112 from the processor 116 via the internal bus module 114 and transmitted over the network 106. Communication between the network interface module 112 and the processor 116 over the internal bus module 114 may be time synchronized to substantially eliminate any latency caused by communication of streaming audio/video data over the internal bus module 114. Thus, the processor may be time aware, in the AVPM system. Accordingly, multiple streams of media data may be synchronized and rendered by the processor 116 correctly in time with respect to each other. The processor 116, in response to a routing command, may process media stream samples included in the payload data of a time-stamped packet 108. This may involve the processor 116 buffering the media stream samples so that the processor 116 may generate a media stream from the media stream samples at the appropriate time. For example, if the timestamp 126 in the packet 108 with the media stream samples is a presentation time, then the processor 116 may generate a local media stream from the media stream samples when the RTC 144 at the processor 116 subsequently matches the presentation time.

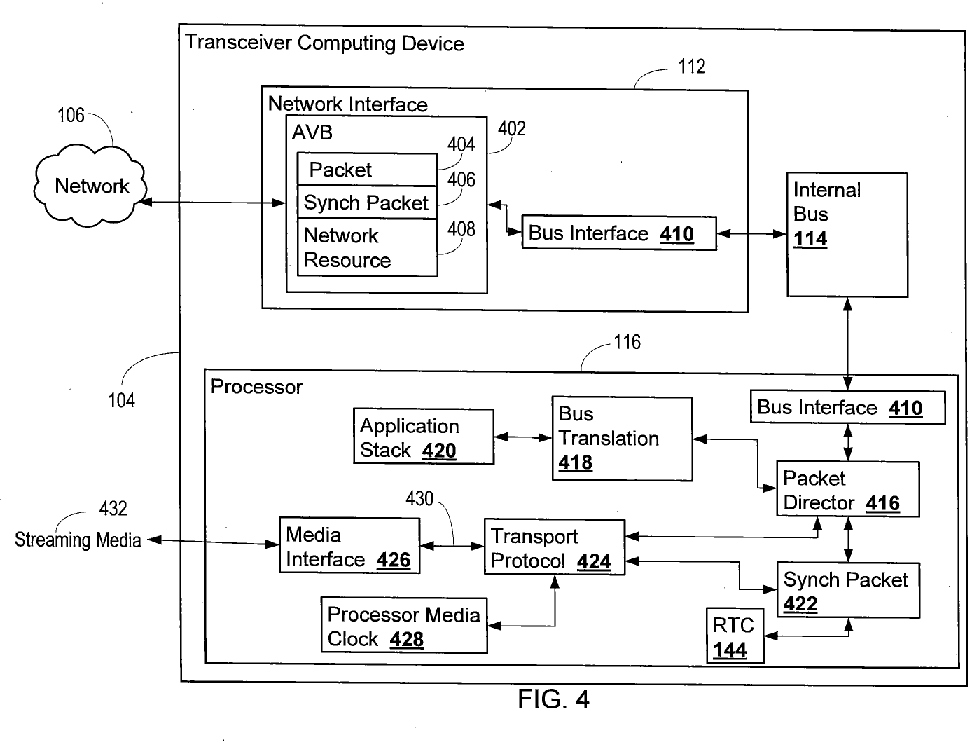

FIG. 4 is an example block diagram of the receiver 104 operable as a transceiver computing device or a transceiver in the AVPM system. In FIG. 4, the transceiver computing device may communicate over the network 106, as previously discussed, to send and receive streaming audio/video data streams. The transceiver computing device may include the network interface module 112, the internal bus module 114 and the processor 116.

The network interface module 112 may include an audio-video bridging (AVB) module 402 that may include a time-stamped packet module 404, a synch packet module 406, and a network resource module 408. In addition, the network interface module 112 may include a bus interface module 410 related to audio video bridging (AVB). The time-stamped packet module 404 may transmit and receive packets over the network 106, such as IEEE 1722 time-stamped packets, as previously discussed. The synch packet module 406 may transmit and receive synch messages, or synch packets over the network 106, such as IEEE 802.1.AS or 1588:2002 packets, as previously discussed. The network resource module 408 may enable reservation of network resources within the network 106 for streaming media data while maintaining quality of service (QoS). More specifically, the network resources module 408 may identify media streams sufficiently to allow determination of resources along a data path through the network 106 to accommodate transmission and receipt of such guaranteed QoS streams. In addition, the network resource module 408 may provide for dynamic maintenance of the identified resources by enabling end-to-end management of these resource reservations. Resource reservation information may be registered, deregistered, and retained by the network resource module 408. An example protocol and procedure for reservation of network resources is described in Stream Reservation Protocol (SRP) IEEE 802.1.Qat. In other examples, other stream reservation procedures and protocols are possible to implement resource reservations along an end-to-end path through the network 106.

The bus interface module 410 may be a peripheral bus interface module providing a communication interface to communicate with the processor 116 over the internal bus module 114. Thus, data to be transmitted with the internal bus module 114 may be formatted by the bus interface module 410. For example, the bus interface module 410 may simply pass packets received from the network 106, such as time-stamped packets, and synch packets to the bus interface module 114 for transmission to the processor 116. Alternatively, data extracted from packets received over the network 106 may be repackage into a predetermined protocol, such as a synch packet protocol, or a time-stamped data protocol, by the bus interface module 410 for transmission by the internal bus module 114. The bus interface module 410 may also pass to the network 106 packets received from the internal bus module 114, such as time-stamped packets or synch packets.

Packets or other information received from the bus interface module 114 may be simply passed through to the network 106, or parsed to determine if processing by the network interface module 112 is needed. Parsing of the packets and information may involve extraction of data, reformatting, combining data from multiple packets to a single packet and/or dividing data received in a single packet into multiple packets. Alternatively or in addition, the bus interface module 410 may extract information from a protocol used by the internal bus module 114, such as by removing a header envelope or other information received from the internal bus module 114 and process the extracted information. Processing of the extracted information may include determining what the information represents and taking appropriate action, repackaging the information in a different protocol, or passing the information on to the network 106, as further described later. The processor 116 may include a bus interface module 410, a packet director module 416, a bus translation module 418, an applications stack module 420, a synch packet module 422, a transport protocol module 424 and a media interface module 426.

The bus interface module 410 may provide a communication interface to communicate with the network interface module 112 over the internal bus module 114 and provide processing of information received from the processor 116 and the internal bus module 114. Processing of information may involve pass through, modification, analysis, and/or extraction, as previously discussed. The bus 114 may operate either synchronously or asynchronously.

The packet director module 416 may analyze the content, such as packets received from the bus interface module 410 to determine if the content is related to audio video bridging, or is some other type of content received over the network 106. Following analysis, the content may be classified by the packet director module 416 and distributed according to the classification. In one example, content may be classified as audio-video bridging content, or any other content received over the network 106. In other examples, any number of classifications may be used to allocate the content.

For content classified as audio video bridging related content, the packet director module 416 may distribute the content to the synch packet module 422, or the transport protocol module 424. For all other content, the packet directory module 416 may distribute the content to the bus translation module 418. Accordingly, operation of the packet director module 416 may be described as an intelligent multiplexor (MUX) capable of analysis and allocation of incoming data or packets.

The packet director module 416 may also provide information to the bus interface module 410 that is outgoing from the processor 116. Information such as time-stamped packets or synch packets may be received from, for example, the synch packet module 422 and the transport protocol 424, and other data may be received from the application stack module 420. In this capacity, the packet director module 416 may operate as a scheduler and/or buffer to supply packets to the internal bus module 114 in accordance with a priority of a respective communication stream. Thus, content such as a media stream may receive a higher priority for transmission across the internal bus module 114, than other content, such as content from the software application stack module 420. Alternatively, the packet director module 416 may be omitted from processing outgoing information, and the bus interface module 410 may independently or dependently prioritize and transmit content across the internal bus module 114.

The bus translation module 418 may process and re-format content received from the packet director module 416 as needed, such as extracting content from packets, prior to passing the information to the application stack module 420. Alternatively, the bus translation module 418 may extract and analyze the content to confirm that the existing format is acceptable to the application stack module 420 and pass along the content to the application stack module 420.

The application stack module 420 may include applications such as zero configuration networking (Zeroconf); a networked service discovery application; a device discovery, enumeration, and configuration control application used in connection management and streaming initiation/termination; or any other applications related to operation of the receiver 116 in the transceiver computing devices 104.

Packets identified as related to AVB may be distributed to either the synch packet module 422 or the transport protocol module 424. For example, packets related to timing synchronization, such as synch packets or 802.1.AS PTP synch packets may be distributed to the synch packet module 422, whereas time-stamped packets having streaming media data, such as IEEE 1722 packets, may be directed to the transport protocol module 424.

The transport protocol module 424 may receive and process the time-stamped packets 108 (FIG. 1) received from the packet director module 416 to generate a local media stream 430 on a per-media clock domain basis from the time-stamped packets. A media clock domain may be the sampling rate of data in a media stream, such as a source media stream at a transmitter from which the time-stamped packets originated. The media clock domain may be 44.1 kilohertz, 48 kilohertz, 96 kilohertz, or 192 kilohertz, for example. The media clock domain may be specific to a type of data, such as video data and/or audio data. One type of data may be transmitted in multiple formats. For example, video data may be transmitted using multiple video resolutions and/or video formats. Each type of data or format may have a corresponding media clock domain. Each type of data and/or each format may be transmitted in accordance with a corresponding one of the media clock domains.

The transport protocol module 424 may provide the local media stream 430 and the processor media clock 428 to the media interface module 426. Alternatively or in addition, the transport protocol module 424 may provide a clock derived from the processor media clock 428 to the media interface module 426. Alternatively, the transport protocol module 424 may provide the local media stream 430 and the processor media clock 428 directly as streaming audio/video 432, and the media interface module 426 may be omitted.

The local media stream 430 may include a media stream that is a recovered copy of a source media stream. In addition, the local media stream 430 may include recovered copies of other source media streams.

The processor media clock 428 may be any periodic signal indicative of a sampling rate of data in the local media stream 430. For example, the processor media clock 428 may be a square wave, a pulse wave, a sinusoid, or any other suitable periodic wave form. The frequency of the processor media clock 428 may be the sampling rate frequency. The frequency of the processor media clock 428 may be a multiple or fraction of the sampling rate of the data in the local media stream 430. In one example, the frequency of the processor media clock 428 may correspond to twice the sampling rate of the data in the local media stream 430. In a second example, the frequency of the processor media clock 428 may be an eighth of the sampling rate. In a third example, where the media stream 430 includes NTSC (National Television System Committee) video, the sampling rate may be a pixel clock rate of 27 MHz and the frequency of the processor media clock 428 may be 15.734 kHz, sometimes referred to as the video line rate.

The processor media clock 428 at the processor 116 corresponds to a master media clock. Specifically, the processor media clock 428 may be synchronized with the master media clock, or may be the master media clock. Accordingly, the processor media clock 428 may be separate from a processor clock of the transceiver computing device and the RTC 142 or RTC clock 144 (FIG. 1): The master media clock may be any periodic signal indicative of a sampling rate of data in the source media stream. Where the processor 116 is the media clock master node, the processor media clock 428 may be the master media clock.

Where the processor 116 is not the media clock master node, the transport protocol module 424 may recover one or more master media clocks from different parts of the network 106. The processor 116 may receive audio/video media streams from multiple transmitters in the network 106 nearly simultaneously, where each one of the media streams may be provided to the transmitters at a rate determined in part by a different one of the master media clocks. Each one of the master media clocks may operate independently from the other master media clocks. For example, the frequencies and periods of the master media clocks may vary. Each one of the master media clocks may have different characteristics than the RTC clocks at the transmitters transmitting respective media streams. Alternatively or in addition, one receiver may receive multiple source media streams from a single transmitter, where each one of the source media streams is sampled at a different rate than the others because the source media streams are sampled at rates determined by multiple master media clocks at the single transmitter. Alternatively or in addition, multiple source media streams may be sampled at a single common rate.

When the processor 116 is not the media clock master node, the transport protocol module 424 may generate the processor media clock 428 based on time-stamped packets received from the network interface module 112 over the internal bus module 114. The transport protocol module 424 may include a frequency synthesizer, such as a Direct Digital Synthesizer (DDS), that generates the local media clock 428. The transport protocol module 424 may determine the period of the master media clock based on a change in a first set of timestamps included in the time-stamped packets. The first set of timestamps may be values of the RTC at a transmitter of the media stream sampled at a frequency determined by the master media clock. For example, the transmitter may generate two packets, one after the other, where each one of the packets includes a timestamp for the portion or portions of the media stream included in that time-stamped packet. The transport protocol module 424 may calculate the period of the processor media clock 428 as a difference between the two received timestamps.

The transport protocol module 424 may read a second set of timestamps from the RTC 144 at the processor 116 by sampling the RTC 144 on an edge of the local media clock 428, such as on a rising edge of the local media clock, a falling edge, or on both. The transport protocol module 424 may determine a period of the processor media clock 428 based on a change in the second set of timestamps. The transport protocol module 424 may adjust the frequency of the processor media clock 428 with the frequency synthesizer in order to limit the difference between the period of the master media clock and the period of the local media clock 428. Once the period of the master media clock and the period of the processor media clock 428 are the substantially identical, the frequencies of the clocks are substantially identical. The processor media clock 428 is syntonized with master media clock when the two clocks have substantially the same frequency, and synchronized with the master media clock when the two clocks have substantially the same phase and substantially the same frequency.

The transport protocol module 424 may determine a phase difference between the master media clock and the processor media clock 428 by comparing one or more of the timestamps in the time-stamped packets with one or more corresponding timestamps read from the RTC 144. If the master media clock and the processor media clock 428 are syntonized, then a difference between a timestamp in one of the packets and a value of the RTC 144 at the processor 116 may indicate the extent of a phase shift between the master media clock and the local media clock 428. The difference between the timestamp in the packet and the value of the RTC 144, when divided by the period of the syntonized master media clock and the local media clock 428, may generate a remainder that indicates the phase difference between the master media clock and the local media clock 428. For example, the phase difference, ΔP, may be determined as ΔP=mod(Y−X, T), where Y is the timestamp in the time-stamped packet generated based on a value read from a remote RTC in a remote transmitter on an edge of the master media clock; X is a local RTC timestamp read from the local RTC 144 on an edge of the local media clock 428; T is the syntonized period; and mod( ) is the modulo operator.

If the phase difference, ΔP, is below a threshold value, and the frequency is substantially the same, then the master media clock and the processor media clock 428 may be considered synchronized. The transport protocol module 424 may adjust the phase of the local media clock 428 with the frequency synthesizer in order to keep the phase difference between the master media clock and the processor media clock 428 below a pre-determined threshold. Further examples of media clock recovery are described in U.S. patent application Ser. No. 12/874,836, entitled “MEDIA CLOCK RECOVERY,” and filed Sep. 2, 2010. In other examples, syntonization and synchronization of the master media clock and the processor media clock 428 may be performed using other methods or mechanisms. The syntonized media stream 430 may be generated using the presentation stamps in the time-stamped packets to synchronize any audio and/or video included in the media contents provided to the media interface module 426.

The media interface module 426 may include a physical transport medium for transporting the media stream 430 to a suitable component. Examples of the media interface module 426 include an I×S (Time-Division Multiplexing) serial connection, an IEC (International Electrotechnical Commission) 60958 SPDIF interface, an MPEG2/4 (Moving Pictures Expert Group) interface, an interface for H.264 Transport Streams, an interface for Bt.601/656 raw video, an interface available from LINKPORT, which is a registered trademark of Compex, Inc. of Anaheim, Calif., or other tangible data transport components capable of providing streaming audio/video 432. The media interface module 426 may also include driver code to read data in the media stream 430, directly or indirectly, such as out of buffer memory. The driver code may transmit the data in the local media stream 430 to other components or devices in the computing device. The media interface module 426 may propagate the local media clock 428, or a clock signal derived from the local media clock 428, to the other components or devices.

The transport protocol module 424 may generate two or more different local media clocks 428 at frequencies for different media clock domains. In addition, the media interface module 426 may provide corresponding media streams. Thus, the processor 116 may receive multiple media streams from one or more transmitters where at least one of the media streams is sampled at a different media clock domain than the other media streams. For example, one of the media streams may be sampled at about 44.1 kilohertz, while another one of the media streams may be sampled at about 192 kilohertz. In this example, the media interface module 426 may provide a first local media stream sampled at about 44.1 kilohertz by generation of a corresponding first local media clock at about 44.1 kilohertz, and a second local media stream sampled at about 192 kilohertz by generation of a corresponding second local media clock at about 192 kilohertz. The media streams may or may not be related.

### First Example Configuration

In a first example configuration in accordance with the previously discussed first operational mode, the synch packet module 422 may perform synchronization and grandmaster selection in accordance with IEEE 802.1.AS or 1588:2002. In this example configuration, the processor 116 may participate as a slave or the grandmaster within the AVPM system, and may perform clock master selection and negotiation, link delay measurement and compensation, and clock rate matching and adjustment using the synch packet module 422. Accordingly, time-stamped packets and synch packets may be received from the network 106 by the network interface module 112 and transferred to the processor 116 over the internal bus module 114. In addition, time-stamped packets and synch packets may be provided from the processor 116 to the network interface module 112 over the internal bus module 114 for transmission over the network 106.

Thus, in this first example configuration the processor 116 may operate as the grandmaster node, or as a slave node. In addition, the RTC 144 of the processor 116 may be synchronized with network time taking into account the latency associated with communication over the network 106, transfer of time-stamped packets by the network interface module 112, and communication over the internal bus module 114. Latency associated with processing by the network interface module 112 and the communication over the internal bus module 114 may have an average transfer latency based on inherent delays in the transceiver computing device, such as interrupt delays, and any other processing time delays by the computing device, including those associated with transmission of data over the internal bus. The transport protocol module 424 may use the network time synchronized RTC 144 to process streaming media packets, such as IEEE 1722 packets, such that the network time has been adjusted to account for the transfer latency of the streaming packets being communicated across the internal bus module 114. In this first example configuration, with regard to the timestamp data packets, the network interface module 112 and the processor 116 may operate as a media clock master node, or as a slave node, as previously discussed.

The internal bus module 114 may be a dedicated communication path between the network interface module 112 and the processor 116. Accordingly, no subscriptions or address identifiers need be applied by the network interface module 112 or the processor 116. Instead, the internal bus module 114 may operate with a protocol specific to the internal bus module 114.

For example, in the case of a computing device operating with a PCI or a PCI-e bus, a dedicated connection, such as a parallel connection or a serial connection, may be established between the network interface module 112 and the processor 116. The dedicated connection may be based on identification and mapping of a link between the network interface module 112 and the processor 116. The internal bus module 114 may communicate internal bus data packets with an internal bus module protocol that is transparent to the network interface module 112 and the processor 116, such as a PCI or PCI-e communication protocol.

In FIG. 3, an example communication protocol using an internal bus data packet 320, such as a PCI packet is illustrated. The example internal bus data packet 320 includes a transaction layer 322, a data link layer 324, and a physical layer 326. The transaction layer 322 may include a header 330 and a data payload 332 generated by the internal bus module 114. As one example of a protocol transparent to both the network interface module 112 and the processor 116, a packet, such as the synch packet 136 may be embedded in the internal bus data packet 320 by storing the synch packet 136 in the data payload 332 of the internal bus data packet 320. In other examples, a time-stamped packet, or any other form of packet or data content may be stored in the data payload 332. Following transmission of the internal bus data packet 320 across the internal bus module 114, which in this example is a PCI or PCI-e bus, the synch packet 136 may be extracted from the data payload 332 of the internal bus data packet 320 and further processed.

Embedding and extracting packets, such as a synch packet 136, in/from the protocol of the internal bus module 114 may be performed by the internal bus module 114 as part of the communication process. Accordingly, neither the network interface module 112 nor the processor 116 may be actively involved in operation of the internal bus module 114. Alternatively, such embedding and extracting may be performed with the bus interface modules 410 included in each of the network interface module 112 and the processor 116.

### Second Example Configuration

In a second example configuration where the AVPM operates in accordance with the previously described first operational mode, the processor 116 may operate as a permanent grandmaster node with the network interface module 112 operating in the network 106 as a proxy for the processor 116. Accordingly, in this example configuration, it is the network interface module 112 that participates in clock master selection and negotiation, performs link delay measurement and compensation, and performs clock rate matching and adjustment with other devices on the network 106. Thus, communication of timing information by the processor 116 may be limited to only the network interface module 112.

Since the RTC 144 of the processor 116 may be the grandmaster clock, an internal bus synch packet used only for the internal bus may be used. The internal bus synch packet may have a different format or protocol than was previously described, and may be communicated over the internal bus module 114 to the network interface module 112. For example, referring to the example synch packet of FIG. 3, the preamble 302, the destination address 304, the source address 306, the VLAN tag 308, and the error check 314 may be omitted to form an internal bus synch packet protocol. Accordingly, in this example, only a data type identifier, such as the Ether-type 310 identifying the content as synch data, and the synch data itself need be transmitted over the internal bus module 114 in the internal bus synch packet in the internal bus synch packet protocol. The synch data may, for example, include only link delay measurement information, compensation and clock rate matching information, and clock rate adjustment mechanisms. Alternatively, the internal bus synch packet may be transmitted as in a synch packet protocol such as an IEEE 802.1AS PTP packet from the processor 116 to the network interface module 112.

In the case where only the timing data and an identifier of the timing data is transmitted as a packet over the internal bus module 114 to the processor 116, the packet director module 416 may distribute the packet to the synch packet module 422. In this example, the synch packet module 422 may include some functionality of the IEEE 802.1AS protocol, however, significant portions may be omitted. Specifically, any negotiation related to establishing the grandmaster node could be omitted from the synch packet module 422. In addition, information related to the PTP version, domain, transport, flags, and interval information could be omitted. Thus, the synch packet module 422 may include only a precise origin time stamp.

Generation by the processor 116 and transmission over the internal bus module 114 of synch packets for all the slaves in the AVPM system may similarly include only the timing data and an identifier of the packet as a synch packet due to the internal bus module 114 being a dedicated connection between the processor 116 and the network interface module 112. Receipt of such a synch packet by the network interface module 112 may be parsed with the synch packet module 406 to determine the packet should not simply be passed through into the network 106. Instead, the network interface module 112 may identify the packet as a synch packet from the processor 116, and extract the timing data therefrom. The synch packet module 406 may then generate a synch packet in the form of, for example, an IEEE 802.1AS PTP packet or an IEEE 1588:2002 packet for transmission to the other devices in the network 106. Grandmaster negotiation and transmission of timing information between the network interface module 112 and other devices on the network 106 may similarly be in accordance with a synchronizing protocol, such as IEEE 802.1AS or 1588:2002 using the synch packet module 406.

With regard to the timestamp packets 108, in the case where the network interface module 112 operates as a proxy for the processor 116, the processor 116 may generate timestamp packets 126, such as IEEE 1722 packets, when the transceiver computing device 104 operates as a transmitter. The timestamp packets 126 may be transmitted across the internal bus module 114 by first being embedded in the internal bus data packet 320 by storing the timestamp packet 108 in the data payload 332 of the internal bus data packet 320. (FIGS. 1 and 3) Following transmission of the internal bus data packet 320 across the internal bus module 114, such as a PCI or PCI-e bus, the timestamp packets 126 may be extracted from the data payload 332 of the internal bus data packet 320 by the network interface module 112. Upon the packet module 404 determining that the timestamp packets 126 are for another device on the network 106, the timestamp packets 108 may be transmitted, or passed, over the network 106 to the destination device, without alteration of the contents of the timestamp packets 106. Alternatively, or in addition, the network interface module 112 may add additional information, such as an indication that the network interface module 112 is a proxy to the processor 116, to the time-stamped packets 108 prior to transmission over the network. In another example, the network interface module 112 may add or change the source address included in the timestamp packet 108. Alternatively, the processor 116 may include a source address indicative of the network interface module 112 in the timestamp packet 108 at the time the timestamp packet 108 is generated.

In another example, the processor 116 may generate dedicated bus data packets for transmission across the internal bus 114. The dedicated bus data packets may be a packet in which at least the timestamp data is omitted. Accordingly, in this example, functionality within the processor 116 to generate timestamp data packets 126 may be omitted. The dedicated bus data packets may be embedded in the internal bus data packet 320, such as a PCI packet, by storing the dedicated bus data packet in the data payload 332 of the internal bus data packet 320. (FIG. 3) Upon receipt of the internal bus data packet 320 from the internal bus module 114, the network interface module 112 may identify the packet as a dedicated bus data packet. The dedicated bus data packet may be extracted from the internal bus data packet 320 by the network interface module 112. In addition, the network interface module 112 may insert RTC timestamps from the RTC 120 of the network interface module 112 before transmission over the network 106.

The network interface module 112 may convert the dedicated bus packet to a timestamp packet, such as an IEEE 1722 packet. Alternatively, the network interface module 112 may simply extract and use the dedicated bus packet if the final destination (receiver) of the dedicated bus packet is the network interface module 112. In another example, the dedicated bus packet may be generated by the processor 116 to substantially comply with a timestamp packet protocol, such as the IEEE 1722 packet protocol, with the exception of omission of time stamps. For example, the dedicated bus packet may be generated such that an Ethernet packet may already be substantially complete i.e. the remainder of the Ethernet frame fields having been formed by (or under supervision of) the processor 116.

In addition, in some examples, the reservation of network resources, such as based on IEEE 802.1Qat, may be handled by the network interface module 112 operating in a proxy capacity for the processor. In other examples, reservation of network resources may be handled by the processor 116. In still other examples, the network interface module 112 can operate to generate a “create reservation packet” and a “delete reservation packet” on behalf of the processor 116.

### Third Example Configuration

In a third example configuration, where the AVPM operates in accordance with the previously described third operational mode, the processor 116 may operate as a slave node to the network interface module 112. In this configuration, the network interface module 112 may fully participate in negotiation and establishment of the grandmaster node, whereas the processor 116 may be maintained permanently as a slave node. In one example, the processor 116 may rely solely on the network interface module 112 for synch packets containing timing information, thus an internal bus synch packet containing only a packet identifier and timing information may be encapsulated in an internal bus communication packet and transmitted over the internal bus module 114, as previously discussed. In another example, synch packets may be provided by the network interface module 112, or any other device operating as the grandmaster node in the AVPM system, such that the synch packets may be in a synch packet protocol, such as IEEE 802.1AS PTP packets. The synch packets 136 in the form of a synch packet protocol, such as IEEE 802.1AS PTP packets may be passed through the network interface module 112 to the internal bus module 114 for encapsulation in the protocol of the internal bus module 114 and transmission to the processor 116 across the dedicated communication path provided by the internal bus module 114, as previously discussed.

In this third example configuration, timestamp packets 108 may be handled similar to the previously described second example configuration. In addition, reservation of network resources may be similarly performed.

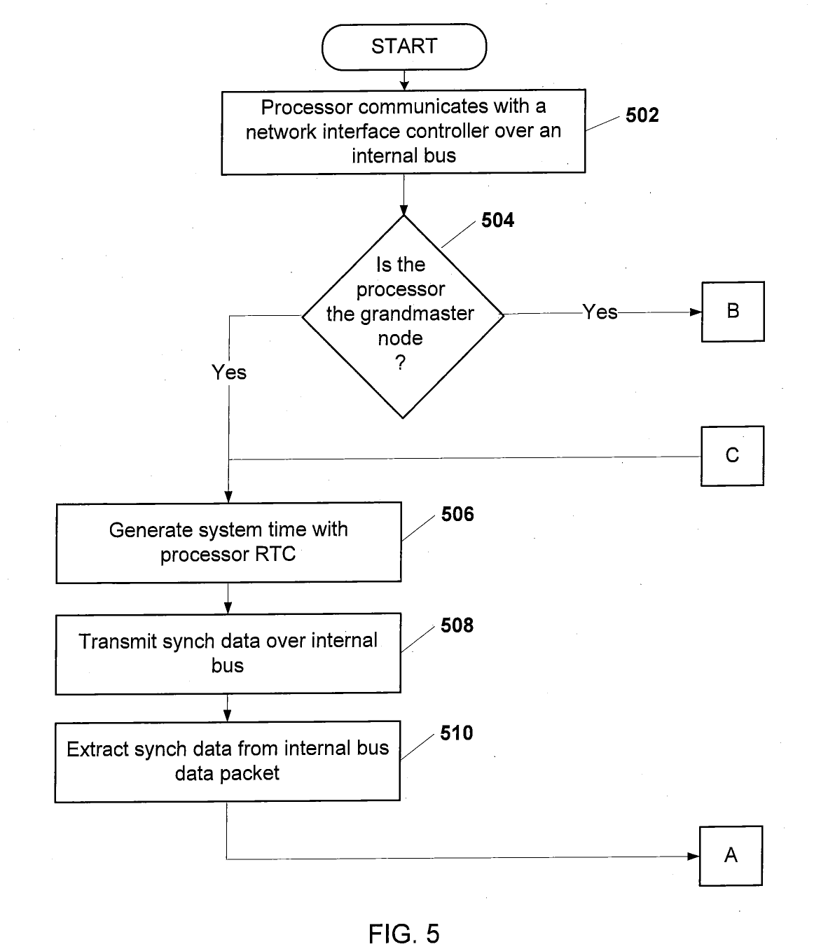

FIG. 5 is an example operational flow diagram of an AVPM system 100 related to network time that is described with reference to FIGS. 1-4. At block 502, a processor 116 included in a transceiver computing device 104 communicates over an internal bus 114 with a network interface controller 112 also included in the transceiver computing device 104. It is determined if the processor 116 is a grandmaster node in the AVPM system 100 at block 504. If the processor 116 is a grandmaster node, the RTC 144 associated with the processor 116 is the grandmaster clock and generates system time for the slave nodes at block 506. At block 508, synch data that includes indication of the system time is transmitted over the internal bus module 114 to the network interface module 112. The synch data may be included in a synch packet, such as an IEEE 802.1AS PTP packet, or an internal bus synch packet, and also may be encapsulated in an internal bus packet, such as an internal bus data packet 320, as previously discussed.

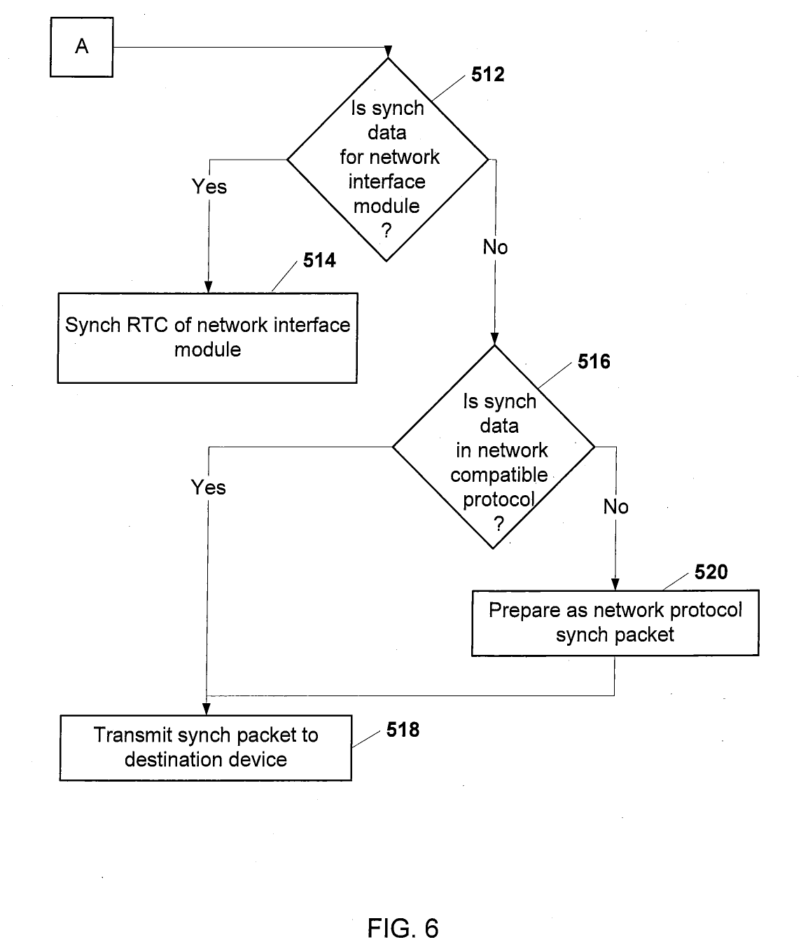

The network interface module 112 may extract the synch packet from the internal bus packet at block 510. In FIG. 6, at block 512 it is determined if the synch packet is for the network interface module 112. If so, at block 514 the RTC 120 of the network interface controller 112 may be synchronized to system time using the synch data. If, on the other hand, the synch packet is identified as being for another device in the network 106, it is determine if the synch packet is in a predetermined protocol, such as IEEE 802.1AS PTP packet protocol, that is compatible with transmission over the network 106 at block 516. If the synch packet is in a compatible predetermined protocol, at block 518 the synch packet is forwarded on to the destination device. If, on the other hand, the synch packet is not in a network compatible format, at block 520 the network interface controller 112 uses the extracted synch information to generate a synch packet in a network compatible format, such as the IEEE 802.1AS PTP packet protocol, and the generated synch packet is transmitted to the destination device at block 518.

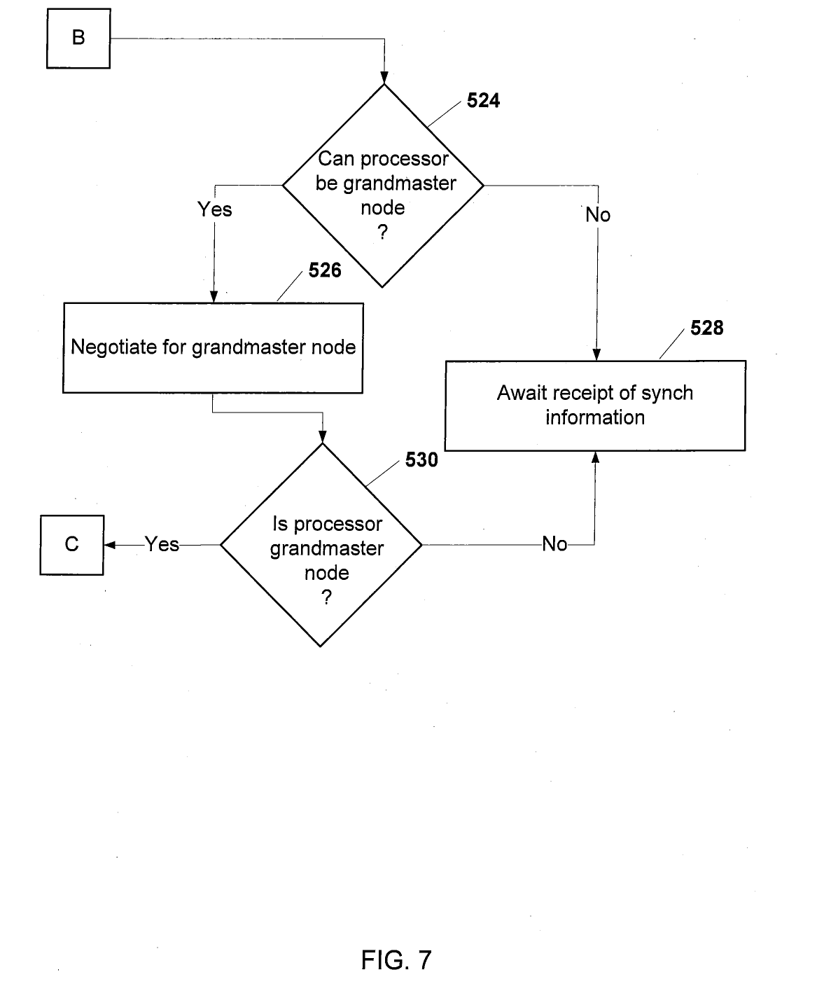

In FIG. 5, if at block 504 the processor 116 is not the grandmaster node, it is determined if the processor 116 is eligible to be the grandmaster node in FIG. 7, at block 524. If so, at block 526, the processor 116 negotiates with the devices in the network 106 (which may include the network interface module 112) over the internal bus 114 via the network interface module 112 to be the grandmaster node. If, on the other hand, at block 524 the processor 116 has been identified as ineligible to be the grandmaster node, then the processor 116 awaits receipt of a synch information over the internal bus 114 from the network interface module 112 at block 528. At block 530, it is determined if the processor was able to negotiate to become a grandmaster node in the network 106. If so, the operation continues at block 504 in FIG. 5, as previously discussed. If the processor is not successful in negotiating to be the grandmaster node, than the processor 116 is a slave node, and the operation proceeds to block 528 to await receipt of synch information provided over the internal bus from the network interface module 112.

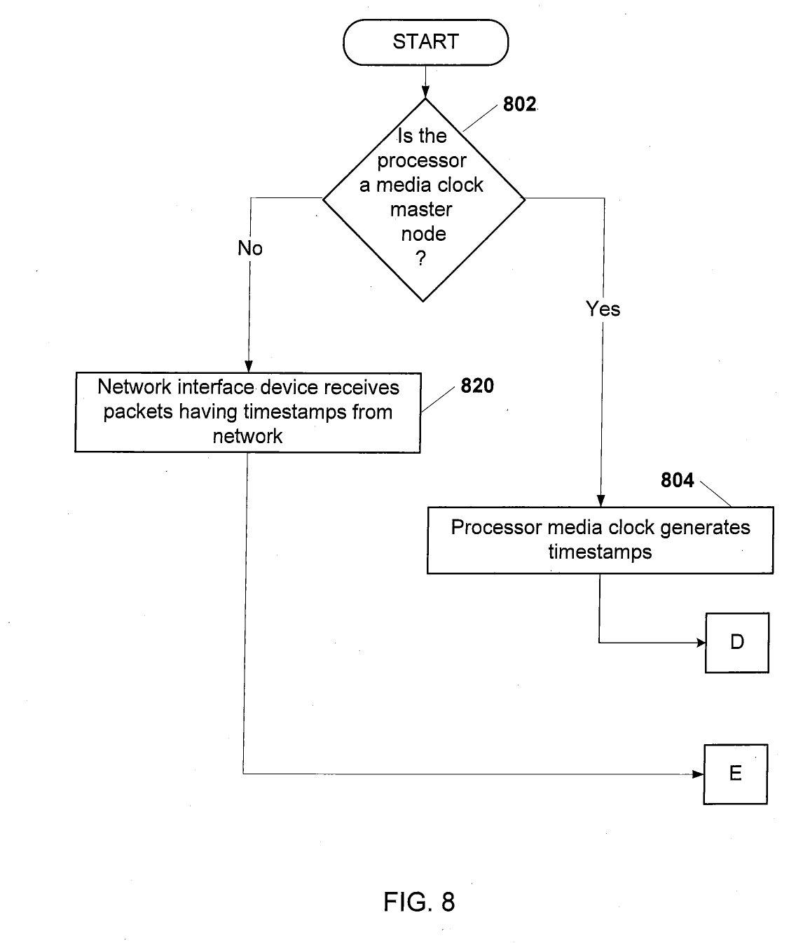

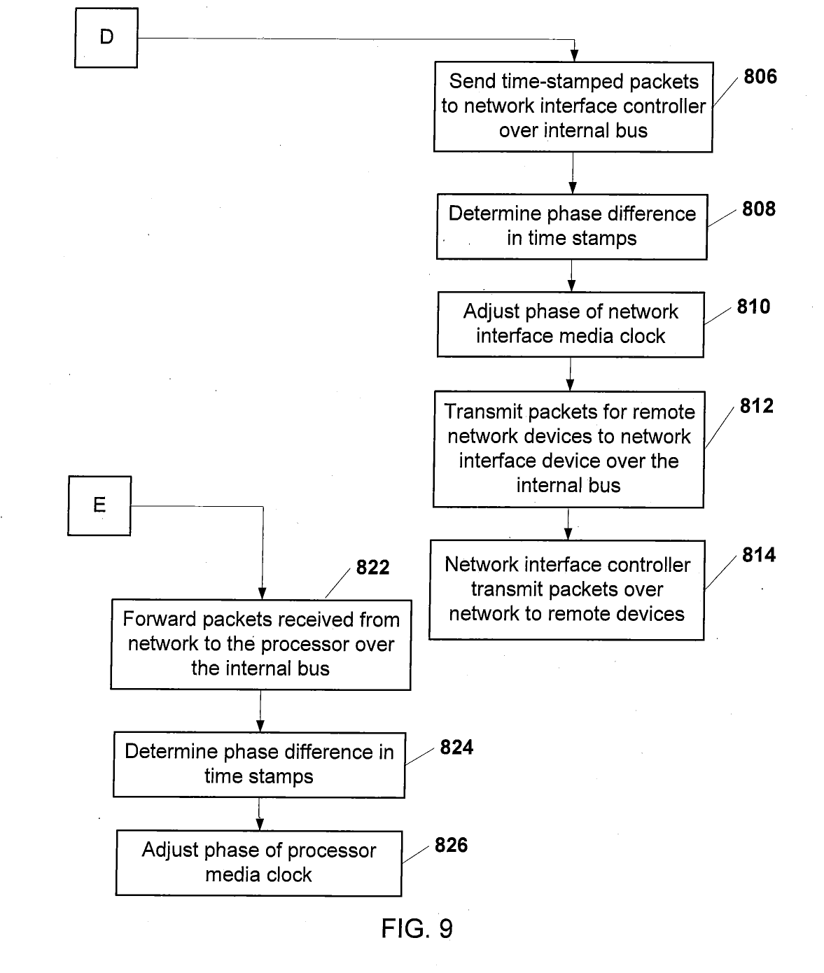

FIG. 8 is another example operational flow diagram of an AVPM system 100 related to time stamps that is described with reference to FIGS. 1-4. At block 802, it is determined if the processor 116 is a media clock master node in the AVPM system 100. If the processor 116 is a media clock master node, a processor media clock associated with the processor is the master media clock 130 and generates timestamps for the slave nodes, or receivers of time stamped packets 108 at block 804. In FIG. 9, at block 806, the processor may provide two or more time-stamped packets that each contain streaming media and a time stamp derived from the master media clock 130 that is sent from the processor 116 to the network interface controller 112 over the internal bus 114. The time stamped packets 108 may be encapsulated in the internal bus data packets 320 for transmission over the internal bus 114, as previously discussed.

The network interface controller 112 may determine a phase difference between the time stamps received in the packets 108 from the processor 116 and timestamps retrieved from the RTC 116 of the network interface controller 112 are above a predetermined threshold at block 808. At block 810, the network interface controller 112 adjusts the phase of a network interface media clock 134. The processor 116 transmits additional packets 108 containing time stamps to other devices in the network 106 by transmitting the packets to the network interface device 112 at block 812. At block 814, the remote devices receive the packets 108 and adjust a phase of a respective remote media clock included in the remote devices.

In FIG. 8, if at block 802, it is determined that the processor 116 is not a media clock master node, at block 820, the network interface device 112 receives over the network 106 at least two data packets containing timestamps from a remote device operating as the media clock master node. In FIG. 9, at block 822, the time stamped packets are forwarded by the network interface controller 112 to the processor 116 over the internal bus 114. The processor 116 determines a phase difference between time stamps retrieved from the RTC 142 of the processor 116 and the time stamps received in the packets is above a predetermined threshold at block 824. At block 826, a phase of the processor media clock 428 is adjusted to synchronize the processor media clock 428 with the master media clock.

Although specific components of innovations were described, methods, systems, and articles of manufacture consistent with the innovation may include additional or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, tables, entities, and other data structures may be separately stored and managed, may be incorporated into a single memory or database, may be distributed, or may be logically and physically organized in many different ways. The components may be included on non-transitory computer readable media encoded with computer readable instructions. The components may operate independently or be part of a same program. The components may be resident on separate hardware, such as separate removable circuit boards, or share common hardware, such as a same memory and processor for implementing instructions from the memory. Programs may be parts of a single program, separate programs, or distributed across several memories and processors.

The respective logic, software or instructions for implementing the processes, methods and/or techniques discussed above may be provided on computer-readable media or memories or other tangible media, such as a cache, buffer, RAM, removable media, hard drive, other computer readable storage media, or any other tangible media or any combination thereof. The non-transitory computer readable media include various types to of volatile and nonvolatile storage media. The functions, acts or tasks illustrated in the figures or described above may be executed in response to one or more sets of logic or instructions stored in or on computer readable media. The functions, acts or tasks are independent of the particular type of instructions set, storage media, processor or processing strategy, and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer, central processing unit (“CPU”), graphics processing unit (“GPU”), or system.

The term “audio/video” or “media” may mean audio, video, or both. Thus, in one example, “audio/video” or “media” means only audio. In a second example, “audio/video” or “media” means only video. In a third example, “audio/video” or “media” means a combination of audio and video.

While various examples of the invention have been described, it will be apparent to those of ordinary skill in the art that many more examples and implementations are possible within the scope of the invention. Accordingly, the invention is not to be restricted except in light of the attached claims and their equivalents.

We claim:

1. A computing device comprising:
a processor having a processor media clock;
a network interface controller having a network interface media clock, the network interface controller configured to transmit and receive packets over an asynchronous network, the packets comprising a media stream and a time stamp, and the network interface controller further configured to synchronize the second media clock to a master media clock; and
an internal bus coupled between the network interface controller and the processor, the processor in bi-directional communication with the network interface controller over the internal bus to communicate the packets;
the processor and the network interface controller configured to communicate over the internal bus to synchronize the processor media clock and the network interface media clock.

2. The computing device of claim 1, where the network interface controller is further configured to communicate a packet comprising the media stream and the time stamp over the internal bus to the processor, and the processor is further configured to synchronize the processor media clock to the master media clock based on the time stamp.

3. The computing device of claim 2, where the master media clock is located elsewhere in the network.

4. The computing device of claim 1, where the processor is further configured to communicate a packet comprising the media stream and the time stamp over the internal bus to the network interface controller, and the network interface controller is further configured to synchronize the network interface media clock to the master media clock based on the time stamp.

5. The computing device of claim 1, where the master media clock is the processor media clock.

6. The computing device of claim 1, where the internal bus is a dedicated communication path that carries communication between the processor and the network interface controller absent addressing identifying the processor or the network interface controller.

7. A computing device comprising:
a processor having a first real-time clock;
an internal bus module in communication with the processor; and
a network interface module in communication with the processor over the internal bus module, the network interface module having a second real-time clock and configured to send and receive communication packets over a network, the communication packets comprising a media stream;
the processor and the network interface module configured to communicate timing information over the internal bus module to synchronize the first real time clock and the second real time clock;
at least one of the processor and the network interface module further configured to generate a respective media clock based on either the first real time clock or the second real time clock and a time stamp received over at least one of the internal bus module or the network.

8. The computing device of claim 7, where the processor comprises a media clock master node, and network interface module is configured to generate a network interface media clock in response to receipt of the time stamp over the internal bus module from the processor, the network interface media clock synchronized with a processor media clock representative of a master media clock.

9. The computing device of claim 8, where the timestamp is a first timestamp, and the network interface module is further configured to retrieve and compare a second timestamp from the second real-time clock to the first timestamp, and adjust a phase of the network interface media clock in response to a phase difference between the first timestamp and the second timestamp being above a predetermined threshold.

10. The computing device of claim 7, where the network interface device, in response to receipt of the timestamp from the network in a communication packet from a media clock master node, is configured to pass the timestamp to the processor over the internal bus module, the processor configured to generate a processor media clock based on the time stamp received from the network interface module, the processor media clock synchronized with a master media clock operable at the media clock master node.

11. The computing device of claim 10, where the timestamp is a first timestamp, and the processor is further configured to retrieve and compare a second timestamp from the first real-time clock to the first timestamp, and adjust a phase of the processor media clock in response to a phase difference between the first timestamp and the second timestamp being above a predetermined threshold.

12. The computing device of claim 7, where the internal bus module is configured to transport information over the internal bus module in an internal bus module protocol that is unknown to the network interface module and the processor.

13. The computing device of claim 7, where the processor is operable as a grandmaster node and the first real time clock is a grandmaster clock, and synch packets transmitted from the processor to the network interface controller include grandmaster clock information used by the network interface controller to synchronize the second real time clock to the first real time clock.

14. A computing device comprising:
a processor having a first real-time clock and a first media clock;
a network interface controller having a second real-time clock and a second media clock; and
an internal bus coupled between the network interface controller and the processor, the processor in bi-directional communication with the network interface controller over the internal bus to communicate synch packets and time-stamped packets, the synch packets comprising synch information, and the time-stamped packets comprising a media stream and a timestamp;
the network interface controller configured to transmit and receive synch packets and time-stamped packets over an asynchronous network;
the processor and the network interface controller further configured to synchronize the first and second real-time clocks using the synch packets, and synchronize the first and second media clocks using the time-stamped packets.

15. The computing device of claim 14, where the network interface controller is operable as a proxy for the processor.

16. The computing device of claim 14, where a destination address and a source address are omitted from synch packets communicated over the internal bus between the network interface controller and the processor.

17. The computing device of claim 14, where the network interface controller is further configured to receive synch packets transmitted by the processor over the internal bus for receipt by a destination device in the asynchronous network, and reformat the synch information into a network compatible protocol prior to transmission over the asynchronous network to the destination device.

18. The computing device of claim 14, where the synch packets and time-stamped packets are encapsulated in an internal bus data packet for transmission over the internal bus.

19. The computing device of claim 14, where the first real-time clock is indicated to the network interface controller as a permanent grandmaster clock.

20. A method of operation of a computing device comprising:
executing a processor included in the computing device;
executing a network interface module included in the computing device to transmit and receive packets over a network, the packets including streaming media;
counting with a first real-time clock associated with the network interface module;
counting with a second real-time clock associated with the processor;
communicating synch information between the processor and the network interface module over an internal bus included in the computing device;
synchronizing the first real-time clock and the second real-time clock using the synch information;
receiving a time stamp with one of the processor and the network interface module over the internal bus; and
synchronizing a respective media clock associated with the processor or the network interface module with a master media clock based on the time stamp and at least one of the first real-time clock and the second real-time clock.

21. The method of claim 20, where receiving the time stamp comprises encapsulating the time stamp in an internal bus data packet with streaming media, and transmitting the internal bus data packet over the internal bus.

22. The method of claim 20, where communicating synch information comprises transmitting the synch information in an internal bus synch packet over the internal bus, the internal bus synch packet transmitted without including a source address or a destination address.

23. The method of claim 20, where receiving the time stamp comprises receiving a packet that includes the time stamp and streaming media with the network interface module, determining, with the network interface module, that a destination of the packet is the processor, and transmitting the packet over the internal bus to the processor.
